(19) United States
(12) Patent Application Publication
(10) Pub. No.: US 2010/0198758 A1
(43) Pub. Date: Aug. 5, 2010

(54) DATA CLASSIFICATION METHOD FOR UNKNOWN CLASSES

(76) Inventors: Chetan Kumar Gupta, Austin, TX (US); Abhay Mehta, Austin, TX (US); Song Wang, Austin, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/364,442

(22) Filed: Feb. 2, 2009

(51) Int. Cl. G06F 15/18

(52) U.S. Cl. 706/12

(57) ABSTRACT

A system and method for creating a CD Tree for data having unknown classes are provided. Such a method can include dividing training data into a plurality of subsets of node training data at a plurality of nodes arranged in a hierarchical arrangement, wherein the node training data has a range. Furthermore, dividing node training data at each node can include, ordering the node training data, generating a plurality of separation points and a plurality of pairs of bins from the node training data, wherein each pair of bins includes a first bin and a second bin with a separation point being located between the first bin and the second bin, and classifying the node training data into either the first bin or the second bin for each of the separation points, wherein the classifying is based on a data classifier. Validation data can be utilized to calculate the bin accuracy between the node training data bin pairs and the validation data bin pairs for each separation point, and the separation point having a high bin accuracy can be selected as the node separation point.

### BACKGROUND

One difficulty that arises in the area of data management is the problem of classification of data with unknown data classes. Given a particular data set, it would be beneficial to be able to divide the data set into contiguous ranges and predict which range (or class) a given point would fall into. As an example, data warehouse management systems desire to estimate the execution times of a particular query. Such estimations are difficult to perform even with only moderate accuracy. In many workload management situations it is often unnecessary to estimate a precise value for execution time, but rather it is sufficient to produce an estimate of the query execution times in the form of time ranges.

There are numerous additional examples of problems where classification with unknown classes (i.e. predicting ranges when the number and sizes of ranges is not predetermined) is important. For example, predicting price categories, classifying customers based on their total value, classifying patients into medical risk categories based on physical characteristics, etc. Accordingly, it would be useful to develop methods whereby the classification of data with unknown classes can be accurately applied.

### BRIEF DESCRIPTION OF THE DRAWINGS

FIG. 1 is a flow chart depicting a method for creating a node of a CD Tree for data having unknown classes in accordance with yet another embodiment.

FIG. 2 is a schematic illustration of a CD Tree data structure in accordance with one embodiment.

### DETAILED DESCRIPTION OF EXAMPLE EMBODIMENTS

Features and advantages of the invention will be apparent from the detailed description which follows, taken in conjunction with the accompanying drawings, which together illustrate, by way of example, features of the present invention.

A binary tree structure can be utilized to address the problem of classifying data where the data classes are unknown. Such a Class Discovery Tree (CD Tree) “discovers” data classes that are not known a-priori during the building phase of the data structure. Thus, the CD Tree is a binary tree where each node represents a data range, and each node is associated with a classifier that divides the range into two bins or bins to obtain a nested set of ranges.

CD Trees can also be utilized for data classification with data sets having a large number of classes. Such an approach can group classes into a smaller number of subclasses, and predict new class labels for these smaller data groups.

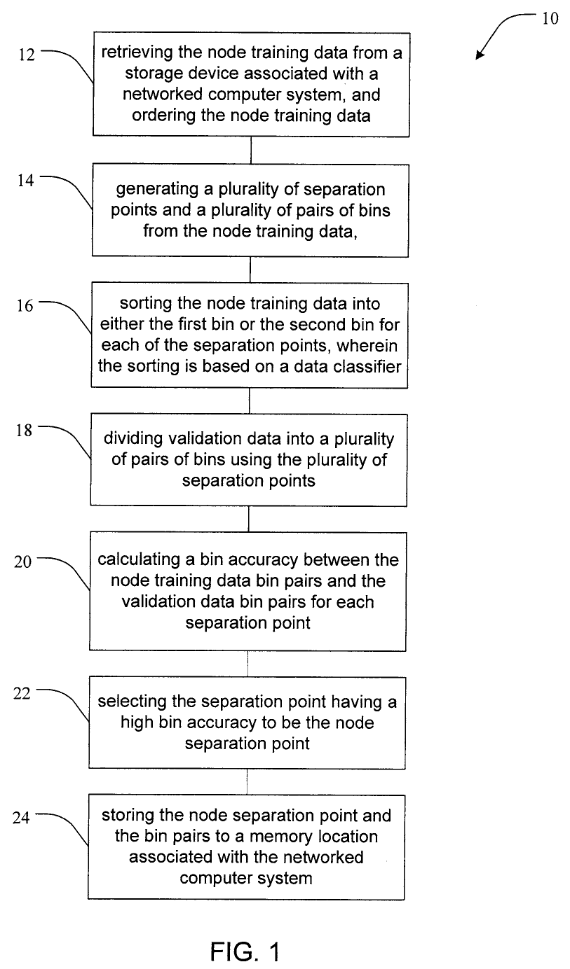

In one embodiment, as is shown in FIG. 1, a method 10 for creating a CD Tree for data having unknown data classes is provided. Such a method can include dividing training data into a plurality of subsets of training data at a plurality of nodes that are arranged in a hierarchical arrangement. Furthermore, dividing node training data at each node can include retrieving the node training data from a storage device associated with a networked computer system, ordering the node training data 12, and generating a plurality of separation points and a plurality of pairs of bins from the node training data 14. In this case, each pair of bins includes a first bin and a second bin with a separation point being located between the first bin and the second bin. The method can also include classifying the node training data into either the first bin or the second bin for each of the separation points, where classifying is based on the values of the node training data using a data classifier 16.

The method can additionally include dividing validation data into a plurality of pairs of bins using the plurality of separation points 18 and calculating a bin accuracy. The separation point 20 having a high bin accuracy can be selected to be the node separation point 22. Furthermore, the node separation point and the bin pairs can be stored to a memory location associated with the networked computer system 24. The method can additionally include repeating dividing node training data until a termination condition is reached.

In another aspect, a CD Tree data structure system is provided, and such a system includes a network of computers and a CD Tree data structure resident on a storage device associated with the network of computers, where the CD Tree data structure has been created according to the method described above.

When building such a CD Tree, it can be helpful to keep in mind certain properties of the tree. Not every property is necessarily used for every CD Tree, and it is noted that the following properties are presented as merely useful guidelines. First, data ranges should be sufficient in number to disallow the prediction that all data belongs to a single range. In other words, it is not helpful if it can be predicted with 100% accuracy that new example data belongs to the entire range. Second, the span of any range should be meaningful. In other words, very small or very large ranges may not be useful. Third, it may be helpful if a user is able to choose a tradeoff between the accuracy of prediction and the number and size of the ranges. Fourth, it may be helpful if the model for prediction is cheap to build and deploy.

The following definitions may be useful in clarifying much of the following discussion regarding CD Trees. It should be noted that these definitions should not be seen as limiting, and are merely presented for the sake of clarification. For the purposes of this discussion, a range of a set of points is defined as the span of y values for that set of points.

Definition 1: The range of a set of points is range=yₘₐₓ−yₘᵢₙ, where yₘₐₓ is the maximum value and yₘᵢₙ is the minimum value for all yᵢ corresponding to the set of points. The predicted range or the class of a point is essentially the range into which the point is predicted to fall into.

Definition 2: The class or range of a data point is the range yₐ<yᵢ<y_{b}, where yₐ and y_{b} are the bounds of some predicted interval in which yᵢ lies. It is thus useful to predict a range for yᵢ using a CD Tree.

Definition 3: A CD Tree, denoted by Tₛ, is a CD Tree such that:

1. For every node u of Tₛ there is an associated range (uₐ; u_{b}).

2. For every node u of Tₛ, there is an associated 2-class classifier fᵤ.

3. The node u contains examples Eᵤ, on which the classifier fᵤ is trained.

4. The node u contains examples Vᵤ which are used for validation.

5. fᵤ is a classifier that decides for each new point i if i should go to [uₐ; uₐ+Δ) or [uₐ+Δ; u_{b}], where Δε (0; u_{b}−uₐ).

6. For every node u of Tₛ, there is an associated accuracy Aᵤ, where accuracy is measured as the percentage of correct predictions made by fᵤ on the validation set Vᵤ.

In one embodiment, a CD Tree is a CD Tree where every node of the tree represents a range, and the childrens' node ranges are non-overlapping subsets of the parent node range, and these ranges form a tree of nested ranges. Every node contains a set of examples (Eᵤ), or node training data, and a validation set (Vᵤ). The y values of points in Eᵤ and in Vᵤ fall in the range of the node u. Conversely, from all the examples in the data set, the points whose y value falls in the range of node u are in Eᵤ and from all the examples in the validation set, the points whose y value falls in the range of node u are in Vᵤ.

In addition to finding the two sub-ranges for the range of a node when building a CD Tree, a classifier is also needed that can predict the two ranges (i.e., a combination of two meaningful classes and a classifier needs to be established at each node). In one embodiment, a set of classifiers F for the entire CD Tree can be set a priori. For example, one set of classifiers could contain the well known algorithms of Nearest Neighbor, C4.5, and Logistic Regression. Thus, for every node a set of possible separation points S is computed from the points in the example set Eᵤ. For each f ε F and each s ε S a classifier can be built on the example set Eᵤ. From these combinations of classifiers and ranges, the combination with the highest accuracy on the validation set Vᵤ can indicate which separation point and the classifier that can be chosen to establish the subsequent set of nodes.

Once a CD Tree is built, a new data point Xᵢ can be entered into the tree where Xᵢ can traverse down the CD Tree from the root node to a leaf l. The range of the leaf l is thus the predicted range for the point Xi. In some embodiments, a user can select any range from the set of nested ranges that lie on the path of Xᵢ from the root to the leaf l.

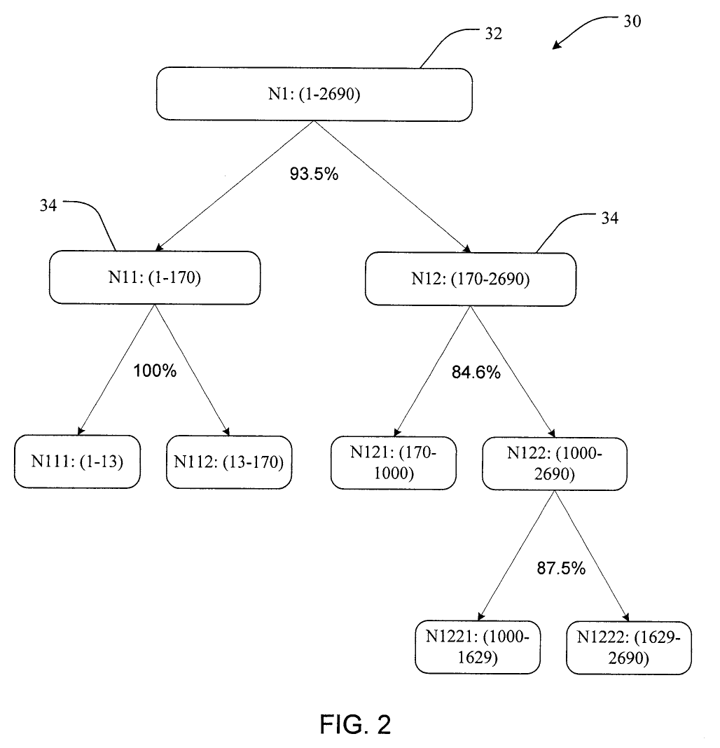

As one example, a sample CD Tree is shown in FIG. 2. This example CD Tree 30 shows data from experiments attempting to predict the execution time of a database query. The classifier (fᵤ) associated with root node 32 is a classification tree with a time range of (1; 2690) seconds. This root node has two children 34 that divide the range into (1; 170) and (170; 2690) seconds. The associated accuracy of this classifier is 93.5%. For 93.5% of the example queries in the validation set Vᵤ of the root node, the classifier was able to predict whether the time range was in (1; 170) or (170; 2690) seconds. The remaining nodes can be similarly understood.

Various methodologies can be utilized to build a CD Tree according to aspects of the present invention. As has been described, a CD Tree can be built by recursively splitting the range of the parent node training data until some termination condition is reached. More specifically, all of the node training data can first be placed into the root node. Node training data can be defined as data that will be used to construct the various nodes of the CD Tree. A point p=(Xₛ; yₛ) is found such that yₛ lies within the range of node training data points in the node. The node is then split into two children nodes such that all points with yᵢ<yₛ go into the left node and all points with yᵢ≧yₛ go into the right node. The nodes are then recursively split in the same manner until a termination condition is reached.

Node construction can be further described as follows: For a node u, all data points in the node training data set Eᵤ are ordered for values yᵢ for all (Xᵢ; yᵢ). In one specific embodiment, the node training data can be ordered in an ascending or a descending order. Subsequently, a plurality of separation points(S), or class boundaries, is generated based on the node training data. In one specific embodiment, the mean of all successive pairs of yᵢ are determined to define a set of possible separation points. In another specific embodiment, the lesser of two points or the greater of two points of all successive pairs of yᵢ are determined to define a set of possible separation points.

It may be beneficial to eliminate a portion of the separation points that are unlikely to be useful in building the CD Tree. Such exclusions may be made on the bases of, for example, the number of data points in a node, the range of data in a node, etc. In one embodiment, removing a portion of the plurality of separation points includes removing those separation points that are associated with a first bin or a second bin containing node training data having a range of less than a minimum range. The minimum range can include any minimum range that is useful given the data set being utilized. In another embodiment, removing a portion of the plurality of separation points includes removing those separation points that are associated with a first bin or a second bin containing a number of node training data points that is less than a minimum number of data points. The minimum number of points can vary depending on the data being analyzed, and thus can include any minimum number of points.

As has been described, for each f ε F and each s ε S a classifier can be built on the example set Eᵤ. Thus Eᵤ is classified into two subsets or bins on either side of each potential separation point. One subset includes the condition that yᵢ<s and the other, that, yᵢ≧s. Thus, this step gives several pairs of classification functions and potential separation points (f; s). Then, for each pair (f; s), the accuracy of predicting the two classes is computed based on the validation set Vᵤ, i.e., Vᵤ is divided based on the separation points and the accuracy of predicting the division with f is computed. Subsequently, a potential separation point (f; s) having a high accuracy can be selected as the separation point for a particular node. In one embodiment, the potential separation point (f; s) having the highest accuracy can be selected to establish the node separation point. Accordingly, for the node u, fᵤ is the classifier, and the sub-ranges of the node training data at that node are based on s.

As an example, assume that node u includes 10 points having y values that are 16, 2, 5, 9, 5, 17, 3, 14, 2, and 3. Also let the classifiers be the 1-Nearest Neighbor and C4.5 algorithms. Set min_{IntervalSize}=4 and min_{Example}=6. The threshold range of the y values below which a node is not subdivided further is referred to as min_{IntervalSize}. Additionally, the threshold number of y values below which a node is not subdivided further is referred to as min_{Example}.

y values are arranged into an ascending order to get {2, 2, 3, 3, 5, 5, 9, 14, 16, 17}. A set of separation points is then computed by taking the mean of adjacent pairs of y to generate points S={2, 2.5, 3, 4, 5, 7, 11.5, 15, 16.5}. Separation points are then removed that are unlikely to produce beneficial results. By applying the function (min_{IntervalSize})/2, those y values having interval sizes of less than 2 (i.e., 4/2) are eliminated, namely, separation points {2, 2.5, 3, 4} and {16.5}. Additionally, by applying the function (min_{Example})/2, those y values having a number of example points less than 3 (i.e., 6/2) are eliminated, namely, separation points {2, 2.5, 3, 4} and {15, 16.5}. The reason the separation points are removed according to (min_{Example})/2 and (min_{IntervalSize})/2 and not min_{Example} or min_{IntervalSize} is because it may be beneficial to split a node that has min_{Example} examples and has a range of min_{IntervalSize} size. If data points had been removed according to min_{Example} or min_{IntervalSize}, a node cannot be split that contains less than 2*min_{Example} or that has a range less than 2*min_{IntervalSize}.

After removing the possible separation points, S₀={5, 7, 11.5} where S₀ is the remaining set of possible separation points. Each point is then considered in turn, and the accuracy of splitting the validation set Vᵤ at each separation point is calculated. Splitting Vᵤ at point 5, the accuracies using the two classifiers 1-Nearest Neighbor and C4.5, respectively, are 70% and 72%. Similarly, for 7, the accuracies are 75% and 73%, and for 11.5, the accuracies are 67% and 68%. As separation point 7 has the highest accuracy, it is selected as the separation point for that node, while the classifier is selected to be Nearest Neighbor, because it gives the highest accuracy of 75%.

As has been suggested above, it can additionally be beneficial to establish a termination condition to terminate the division of training data into nodes if the range for a node is too small to produce useful information. In one embodiment, subdivision of node training data can be terminated when the range of a node falls below a threshold value. This threshold value, or min_{InteralSize}, functions as a stopping point once the node training data has been subdivided past that threshold point. This helps to assure that a class is meaningful, and that it contains at least a minimum number of data points. Furthermore, in another embodiment, subdivision of the node training data can be terminated when the number of training data points in a node falls below a minimum threshold, min_{Example}. These termination criteria do not ensure that the range of any node will not be less than min_{IntervalSize}, or that a node will contain less than min_{Example} number of points, but rather that a node containing, for example, less than min_{Example}, will not be subdivided.

### EXAMPLES

### Example 1

### Predicting Execution Times for Queries

The following example is about a database that is installed on a computer system having multiple processors. There are a total of 769 queries in this data set, and twelve different workloads are created by running a different number of queries simultaneously. For each query in each workload the execution times were noted. The X values for each query are certain properties of the query and the load on the system, and the y values are the execution times. Thus, each workload provides a data set.

Naive Approach:

Additionally, the CD Tree is compared to a naive approach to building a CD Tree. The naive approach is a two step process: 1) the data set is first clustered on the y-values, and 2) a multiclass classifier is fit on this data. A basic algorithm is constructed to accomplish the clustering (note that clustering requires that the number of clusters be known).

Let the number of clusters be n_{c}.

1. Using simple k-means, find the n_{c} clusters.

2. If all the clusters meet the min_{Example} and min_{IntervalSize} constraints, then stop.

3. Increase the numbers of clusters by 1 in k-means.

4. Assign the points of all the clusters that do not meet the criterion to the cluster with the centroid nearest to them in terms of Euclidean Distance.

5. Count the number of clusters, if it is n_{c}, then stop, otherwise goto Step 3.

Once the clustering of the data has been completed, the clusters can be used as class labels. For a fair comparison, take all f ε F and make multiclass classifiers with 1-against all with each f. Then for each multiclass classifier, compute the accuracy on the test set. The highest accuracy amongst all these classifiers is then reported.

CD Tree Approach:

For each data set, ten different test sets are created by randomly distributing 60% of the data points as a training set, 20% of the data points as a test set, and 20% of the data points as a validation set. First, the results are present for a complete CD Tree. The averages for the ten runs per data set are tabulated and compared to the results with the average of the naive approach. The fourth column of Table 1 is the average number of ranges obtained with the CD Tree. 1-Nearest Neighbor and Decision Tree algorithms are used as classifiers. The results are obtained with min_{IntervalSize}=1 and min_{Examples}=25. Results are shown in Table 1.

TABLE 1
Execution Times for Queries

| Data Set | CD Tree | Naive | Ranges |
|---|---|---|---|
| 1 | 79.87 | 65.73 | 9.6 |
| 2 | 77.71 | 74.05 | 10.1 |
| 3 | 72.16 | 64.57 | 10.2 |
| 4 | 66.01 | 51.84 | 11.2 |
| 5 | 53.20 | 50.38 | 13.2 |
| 6 | 68.44 | 62.97 | 12.9 |
| 7 | 66.41 | 56.68 | 13.5 |
| 8 | 72.45 | 62.09 | 13.4 |
| 9 | 65.22 | 56.98 | 14.2 |
| 10 | 70.93 | 63.08 | 12.1 |
| 11 | 73.38 | 66.69 | 11.3 |
| 12 | 69.87 | 57.28 | 12.9 |

Next, the results are presented when minimum accuracy is introduced and set to 0.80. The above calculations are then repeated using the same parameters, and the results are shown in Table 2.

TABLE 2
Execution Times for Queries with Minimum Accuracy = 0.80

| Data Set | CD Tree | Naive | Ranges |
|---|---|---|---|
| 1 | 95.43 | 89.76 | 3.6 |
| 2 | 89.81 | 84.11 | 4.8 |
| 3 | 81.67 | 83.76 | 5.4 |
| 4 | 72.67 | 67.25 | 9.4 |
| 5 | 82.67 | 79.23 | 7.7 |
| 6 | 69.30 | 65.59 | 12.3 |
| 7 | 70.81 | 66.08 | 11.9 |
| 8 | 76.70 | 67.13 | 11.7 |
| 9 | 72.86 | 64.10 | 12.3 |
| 10 | 72.46 | 66.80 | 11.6 |
| 11 | 76.59 | 74.84 | 9.9 |
| 12 | 72.98 | 64.28 | 12.0 |

It can be seen that CD Tree again outperforms the naive approach as is the case in Table 1. It can also be seen that the accuracy goes up for all data sets and the number of ranges goes down. This can be a desired effect of introducing the minimum accuracy criterion.

### Example 2

### Multiclass Classification with Large Numbers of Classes

The CD Tree approach can be used in a multiclass classification problem where there are a large number of classes. CD Tree will automatically group these classes into a smaller number of classes. To demonstrate this, an Abalone data set that predicts the age of abalone from physical measurements is utilized. The number of attributes is categorical, real and integer, and the number of instances is 4177. The number of classes is 29, which is a difficult data set to classify. The accuracy on this data set is known to 72.8% when the classes are grouped into three classes, and previous results are only 65.2%, which was also divided into three classes.

The results for this problem are obtained with three minimum interval sizes of min_{IntervalSize}=3, 4, and 5, and min_{Examples}=25, min_{accuracy}=0.80, and nₛₖᵢₚ=0.25. Similar to Example 1, test sets are created by randomly distributing 60% of the data points as a training set, 20% of the data points as a test set, and 20% of the data points as a validation set. 10 runs are created, and the results from these 10 runs are reported as averages. The results are presented in Table 3. It can be seen that with all three approaches, a high accuracy and a larger number of ranges (group of classes) are obtained. For the CD Tree with min_{accuracy}+nₛₖᵢₚ, not only is the accuracy higher than the best known result, but the number of classes is also higher. Additionally, the algorithm discovers the groupings of the classes on its own. In previous approaches, the many classes have been grouped into three classes by the researchers of the original data.

TABLE 3
Abalone Age Data Accuracy

| Method | CD Tree | Naive | Range |
|---|---|---|---|
| min_{accuracy} | 70.93 | 52.08 | 5.2 |

### Example 3

### Boston Housing Data

The following data set is of housing prices in Boston. It is obtainable from the UCI repository. The data set has 14 attributes of real, integer types, and 506 instances. Like the previous experiments, 60% of the data is used for training, 20% for validation and the last 20% for testing. 10 runs are created and the averages are reported. The results for complete CD Tree are obtained with min_{intervalSize}=10 and min_{Examples}=25. When min_{accuracy} is added, it equals 0.80, and nₛₖᵢₚ is equal to 0.25. The results are presented in Table 4. There is an increase in overall accuracy at the expense of ranges as the analysis moves away from the Complete CD Tree. However, there is not a significant improvement with the addition of nₛₖᵢₚ, in this case. This could be because no classes could be found in the portion of ranges that were to be skipped, which had accuracy greater than min_{accuracy}.

Some of the sample ranges are:
1. With five ranges: {[5.0, 12.6]; [12.6, 25.1]; [25.1, 31.5]; [31.5, 37.2]; [37.2, 50.0]}. These ranges are obtained without nₛₖᵢₚ
2. With six ranges: {[5.0, 12.6]; [12.6, 17.8]; [17.8, 25.1]; [25.1, 31.5]; [31.5, 37.2]; [37.2, 50.0]}. These are obtained with nₛₖᵢₚ.

TABLE 4
Boston Housing Data

| Method | CD Tree | Naive | Range |
|---|---|---|---|
| min_{accuracy} | 72.24 | 66.63 | 5.3 |

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method for data classification and creating a CD Tree for data having unknown classes including dividing training data into a plurality of subsets of node training data at a plurality of nodes arranged in a hierarchical arrangement, wherein dividing node training data at each node comprises:
retrieving the node training data from a storage device associated with a networked computer system, and ordering the node training data;
generating a plurality of separation points and a plurality of pairs of bins from the node training data, wherein each pair of bins includes a first bin and a second bin with a separation point being located between the first bin and the second bin;
classifying the node training data into either the first bin or the second bin for each of the separation points, wherein the classifying is based on values of the training data by utilizing a data classifier;
dividing validation data into a plurality of pairs of bins using the plurality of separation points;
calculating a bin accuracy between the node training data bin pairs and the validation data bin pairs for each separation point;
selecting the separation point and the classifier having a high bin accuracy to be the node separation point; and
storing the node separation point and the bin pairs to a memory location associated with the networked computer system.

2. The method of claim 1, further comprising repeating dividing node training data until a termination condition is reached.

3. The method of claim 1, wherein ordering the node training data includes ordering the node training data in either a descending order or an ascending order.

4. The method of claim 1, wherein generating the plurality of separation points includes calculating a mean value for adjacent points of node training data.

5. The method of claim 1, wherein generating the plurality of separation points includes selecting the lesser of two points or the greater of two points for adjacent points of node training data.

6. The method of claim 1, further comprising removing a portion of the plurality of separation points prior to classifying the node training data.

7. The method of claim 6, wherein removing a portion of the plurality of separation points includes removing those separation points having a first bin or a second bin containing node training data having a range of less than a minimum range.

8. The method of claim 6, wherein removing a portion of the plurality of separation points includes removing those separation points having a first bin or a second bin containing a number of node training data points that is less than a minimum number of points.

9. The method of claim 1, wherein the classifying of the node training data is based on more than one data classifier.

10. The method of claim 1, wherein selecting the separation point having a high bin accuracy includes selecting the separation point having the highest bin accuracy.

11. The method of claim 1, wherein the termination condition is reached when the node training data range is less than a threshold range.

12. The method of claim 1, wherein the termination condition is reached when a number of node training data points is less than a minimum number of data points.

13. A CD Tree data structure system, comprising:
a network of computers;
a CD Tree data structure resident on a storage device associated with the network of computers, whereby the CD Tree data structure has been created by:
dividing training data into a plurality of subsets of node training data at a plurality of nodes arranged in a hierarchical arrangement, and wherein dividing node training data at each node includes:
ordering the node training data;
generating a plurality of separation points and a plurality of pairs of bins from the node training data, wherein each pair of bins includes a first bin and a second bin with a separation point being located between the first bin and the second bin;
classifying the node training data into either the first bin or the second bin for each of the separation points, wherein the classifying is based on a data classifier;
dividing validation data into a plurality of pairs of bins using the plurality of separation points;
calculating a bin accuracy between the node training data bin pairs and the validation data bin pairs for each separation point;
selecting the separation point having a high bin accuracy to be the node separation point; and
repeating dividing node training data until a termination condition is reached.

14. The system of claim 13, wherein ordering the node training data includes ordering the node training data in an ascending order or in a descending order.

15. The system of claim 13, wherein generating the plurality of separation points includes selecting the lesser of two points or the greater of two points for adjacent points of node training data.

16. The system of claim 13, further comprising removing a portion of the plurality of separation points prior to classifying the node training data.

17. The system of claim 16, wherein removing a portion of the plurality of separation points includes removing those separation points having a first bin or a second bin containing node training data having a range of less than a minimum range.

18. The system of claim 16, wherein removing a portion of the plurality of separation points includes removing those separation points having a first bin or a second bin containing a number of node training data points that is less than a minimum number of points.

19. The system of claim 13, wherein the classifying of the node training data is based on more than one data classifier.

20. The system of claim 13, wherein selecting the separation point having a high bin accuracy includes selecting the separation point having the highest bin accuracy.
